(19) United States
(12) Patent Application Publication
(10) Pub. No.: US 2025/0282013 A1
(43) Pub. Date: Sep. 11, 2025

(54) SYSTEMS, DEVICES, AND METHODS FOR RECLAIMING CUTTING FLUID FOR MACHINING OPERATIONS

(71) Applicant: Quick Turn Precision Machining, Inc., Ogden, UT (US)

(72) Inventors: Whitt Woods, North Ogden, UT (US); Nate Woods, North Ogden, UT (US); Adam Woods, Perry, UT (US)

(21) Appl. No.: 19/071,292

(22) Filed: Mar. 5, 2025

Related U.S. Application Data
(60) Provisional application No. 63/561,946, filed on Mar. 6, 2024.

(51) Int. Cl. B23Q 11/10; B23Q 11/00

(52) U.S. Cl. CPC B23Q 11/1069; B23Q 11/0067

(57) ABSTRACT

The present disclosure relates to systems, devices, and methods for reclaiming cutting fluid used in a machining operation. In particular, in some embodiments, the disclosed systems include a fluid container for collecting a cutting fluid used in a machining operation. Additionally, in some implementations, the disclosed systems include a sensor for detecting a fluid level of the cutting fluid within the fluid container. Moreover, in some embodiments, the disclosed systems include an actuator and a hose assembly for moving cutting fluid from the fluid container toward a reservoir of a machine tool. Furthermore, in some implementations, the disclosed systems include a controller for initiating the actuator upon sensing that the fluid level of the cutting fluid exceeds a predetermined threshold level.

### RELATED APPLICATIONS

This application claims priority to and the benefit of U.S. Provisional Patent Application No. 63/561,946, filed on Mar. 6, 2024 and titled “SYSTEMS, DEVICES, AND METHODS FOR RECLAMATION OF CUTTING FLUID FOR MACHINING OPERATIONS,” the contents of which are hereby incorporated by reference herein in their entirety.

### BACKGROUND

Machining is an important manufacturing process used to convert raw workpieces into components, parts, and products having a wide variety of complexity. Moreover, machine tools are instruments utilized to machine workpieces, and thus machine tools are foundational to manufacturing. An important aspect of machining is cutting fluid (e.g., cutting oil, water-based cutting fluid, etc.), which is commonly used to aid a machining operation to successfully and precisely cut a workpiece into a desired product. Cutting fluids are often expended during the machining process when scrap chips soaked in cutting fluid are discarded or recycled. Therefore, cutting fluids have a consumable cost, and can add significantly to overall machining costs.

### BRIEF SUMMARY

Embodiments of the present disclosure provide benefits and/or solve one or more of the foregoing or other problems in the art with systems, devices, and methods for reclaiming cutting fluids for machining operations. For example, in some embodiments, scrap chips soaked with cutting fluid are captured in a chip bin and held for a period of time to allow at least some of the cutting fluid to drain from the scrap chips. In some embodiments, the cutting fluid is filtered and collected in a fluid container. In addition, in some implementations, cutting fluid is pumped out of the fluid container to be recycled in the machining operation. For example, in some embodiments, a pump returns filtered cutting fluid back to a reservoir of a machine tool to be reused in the machining operation in real time. In some implementations, filtered cutting fluid can be proactively recycled numerous times through this process.

Additionally, in some embodiments, the chip bin is couplable with a draining device to facilitate movement of the chip bin and draining of the cutting fluid from the chip bin. To illustrate, in some implementations, the chip bin interfaces with a plug assembly at a drain on the chip bin. The plug assembly can plug the drain when the chip bin is not coupled with the draining device, and can open the drain when the chip bin is coupled with the draining device. The draining device can be used to open the plug assembly and drain cutting fluid from the chip bin when desired, whereas the chip bin can be used without the draining device to collect scrap chips with cutting fluid when draining is not desired.

The following description sets forth additional features and advantages of one or more embodiments of the disclosed systems, devices, and methods. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a cutting fluid reclamation process in accordance with one or more embodiments.

FIG. 2 illustrates some components of a fluid reclamation apparatus in accordance with one or more embodiments.

FIG. 3 illustrates a fluid reclamation system interfaced with a chip bin and a reservoir of a machine tool, in accordance with one or more embodiments.

FIG. 4 illustrates a portion of a fluid reclamation system, including a cutaway view of a chip bin coupled with a plug assembly and a draining device to drain cutting fluid from the chip bin into a fluid container, in accordance with one or more embodiments.

FIG. 5 illustrates a cross section view of a chip bin (shown with a top portion cutaway) coupled with a plug assembly and a draining device, in accordance with one or more embodiments.

FIG. 6 illustrates a draining device in accordance with one or more embodiments.

FIG. 7 illustrates a plug assembly in accordance with one or more embodiments.

FIG. 8 illustrates a detail cross section view of a plug assembly coupled with a chip bin and interfacing with a draining device in accordance with one or more embodiments.

FIG. 9 illustrates a fluid reclamation apparatus in accordance with one or more embodiments.

### DETAILED DESCRIPTION

This disclosure describes one or more embodiments of systems, devices, and methods for reclaiming cutting fluids for machining operations. To illustrate, when a machine tool is used to machine a workpiece, a cutting fluid is often used to lubricate and cool the workpiece and the machine tool. As the workpiece is cut, scrap chips are a byproduct to be removed from the machine tool. The scrap chips are typically soaked with cutting fluid, and thus, in conventional processes, the cutting fluid is often expended along with the scrap chips. Utilizing embodiments of the systems, devices, and methods disclosed herein, some (e.g., most) of the cutting fluid can be reclaimed (e.g., continuously, or intermittently) and reused in the same or a subsequent machining operation. Thus, the described embodiments provide techniques for reducing replenishment costs of lost cutting fluid, as well as mitigating environmental waste from discarding the cutting fluid. Moreover, by proactively removing some (e.g., most) of the cutting fluid from the scrap chips, the disclosed systems, devices, and methods can increase the scrap value of the scrap chips because the scrap chips are generally easier to recycle with reduced amounts of cutting fluid.

To illustrate, in some implementations, scrap chips soaked in cutting fluid are captured in a chip bin during (or after) a machining operation. The scrap chips and cutting fluid can be held in the chip bin to allow at least some of the cutting fluid to drain off of the scrap chips. The cutting fluid can be drained from the chip bin into a fluid container. In some cases, the cutting fluid is filtered while drained from the chip bin into the fluid container. In one or more embodiments, the chip bin can include an agitator device or a spinning component that causes additional cutting fluid to be removed from the scrap chips by agitating the chips or by using centrifugal force to separate cutting fluid from the scrap chips.

Furthermore, the cutting fluid can be pumped out (e.g., continuously, or intermittently) of the fluid container to be recycled in the machine tool. For example, a pump is triggered to evacuate some (e.g., most) of the cutting fluid from the fluid container and return the cutting fluid back to the machine tool to be reused. In some cases, the cutting fluid can be recycled continuously or numerous times via this process.

In some implementations, the amount of cutting fluid in the fluid container is actively monitored. For instance, a sensor can continuously (or intermittently) detect a fluid level (e.g., a surface level) of the cutting fluid in the fluid container. When the fluid level reaches a high-level mark, the pump can be triggered on to move cutting fluid out of the fluid container and return it to the machine tool. Moreover, when the fluid level reaches a low-level mark (e.g., due to some of the cutting fluid being evacuated from the fluid container), the pump can be triggered off (e.g., via a sensor and/or timer) to allow further accumulation of cutting fluid in the fluid container.

The methods disclosed herein can be performed without human involvement. For example, the cutting fluid can be drained from the chip bin into the fluid container, the fluid level can be actively monitored, and the pump can evacuate cutting fluid from the fluid container to move the cutting fluid back to the machine tool, all automatically without human input.

As illustrated by the foregoing discussion, the present disclosure utilizes a variety of terms to describe features and advantages of the disclosed systems, devices, and methods. For example, as used herein, the term “machine tool” refers to a machine for machining metal or other rigid materials. For example, the term “machine tool” can include a mill, a lathe, a screw machine, a drill, a grinding machine, a saw, a broach, a hone, a shaper, a planer, and a hobbing machine, etc. In some cases, a machine tool includes a CNC machine. Additionally, in some implementations, a machine tool includes a combination machine.

As used herein, the term “machining operation” refers to a manufacturing process that utilizes a machine tool to form a workpiece by removing material from the workpiece. For example, the term “machining operation” can include milling, turning, drilling, grinding, sawing, broaching, honing, shaping, planing, and hobbing, etc.

As used herein, the term “scrap chips” refers to pieces of material removed from a workpiece by a machine tool. For example, scrap chips include shavings and/or swarf produced by contact between the workpiece and the machine tool's bit or blade or other industry standard cutting/drilling tools.

As used herein, the term “cutting fluid” refers to a fluid (e.g., liquid) used to help cut and remove material (e.g., scrap chips) from a workpiece. For example, the term “cutting fluid” can include oils, oil-based solutions, water, water-based solutions, oil-water emulsions, gels, pastes, and other fluids used to machine a workpiece. In some cases, a cutting fluid helps to lubricate contact points between the machine tool and the workpiece. In addition, the cutting fluid can help cool the workpiece and/or prevent scrap chips from fusing to the tool during machining. Moreover, in some cases, the cutting fluid helps to contain, capture, and/or remove the scrap chips from the machine tool.

As used herein, the term “chip bin” refers to a container used to catch or collect scrap chips as they are created by a machining operation. For example, in some cases, after scrap chips are produced during the machining operation, the scrap chips are typically carried by a conveyor toward an end of the machine tool and deposited into a chip bin. In some cases, the scrap chips are soaked in cutting fluid. Thus, the chip bin also catches or collects cutting fluid. In some embodiments, a chip bin has a drain valve at or near the bottom of the chip bin, through which cutting fluid can drain from the chip bin.

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments.

As used herein, the terms “coupled to” and “couplable to” are broad enough to refer to any suitable coupling or other form of interaction between two or more entities, including mechanical, electrical, and/or fluidic interaction. Thus, two components may be coupled to each other even though they are not in direct contact with each other. The phrase “attached to” refers to interaction between two or more entities which are in direct contact with each other and/or are separated from each other only by a fastener of any suitable variety (e.g., mounting hardware or an adhesive).

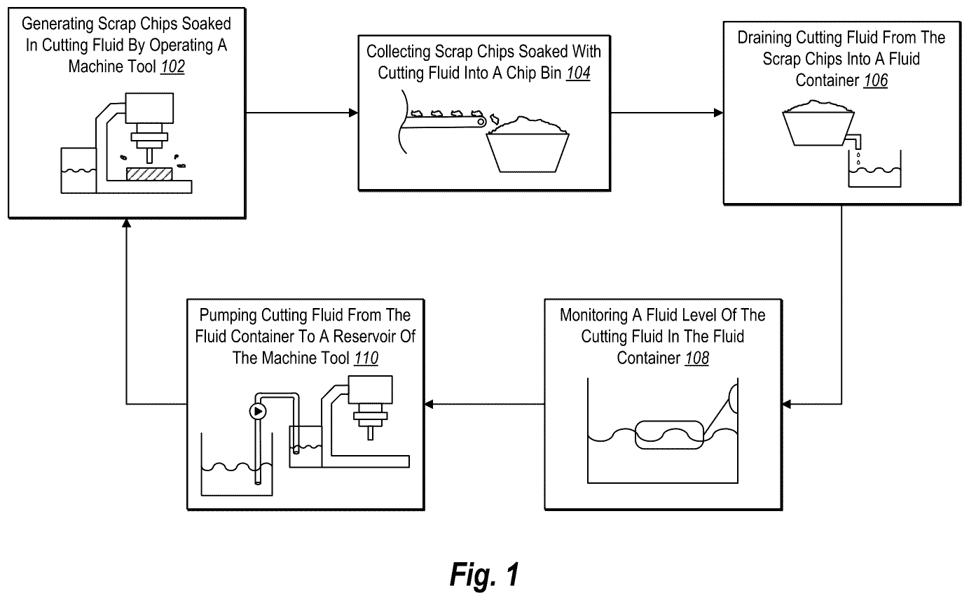

Additional detail will now be provided in relation to illustrative figures portraying example embodiments and implementations of the disclosed systems. For instance, FIG. 1 illustrates a cutting fluid reclamation process in accordance with one or more embodiments. In particular, FIG. 1 shows acts for capturing and recycling evacuated fluids back to a machine tool. In some embodiments, the acts for reclaiming cutting fluid are performed without human involvement or monitoring (e.g., the acts are automated).

As shown in FIG. 1, in some implementations, the fluid reclamation process includes an act 102 of generating scrap chips soaked in cutting fluid by operating a machine tool. To illustrate, a machine tool operator operates a machine tool for machining metal or another rigid material (e.g., to cut a metal workpiece into a new form). As the machine tool cuts the workpiece, scrap chips are produced. In some cases, the scrap chips are saturated with cutting fluid, or otherwise in contact with cutting fluid.

Moreover, as also shown in FIG. 1, in some implementations, the fluid reclamation process includes an act 104 of collecting scrap chips soaked with cutting fluid into a chip bin. To illustrate, in some cases, the scrap chips are carried by a conveyor to an end of the machine tool. The scrap chips are deposited into the chip bin for collection and removal from the machining operation. For example, the scrap chips, upon being collected, can be discarded or recycled.

As further shown in FIG. 1, in some implementations, the fluid reclamation process includes an act 106 of draining cutting fluid from the scrap chips into a fluid container. To illustrate, in some implementations, the scrap chips are left in the chip bin for a period of time or allowed to proactively drain to allow the cutting fluid to disperse from the scrap chips and amass near a bottom of the chip bin. Furthermore, in some implementations, the amassed (e.g., excess) cutting fluid can be drained from the chip bin into the fluid container. In some cases, the amassed cutting fluid is filtered upon relocation from the chip bin to the fluid container.

Moreover, as shown in FIG. 1, in some implementations, the fluid reclamation process includes an act 108 of monitoring a fluid level of the cutting fluid in the fluid container. For example, the cutting fluid is observed or tracked (e.g., continuously, or intermittently) to determine whether the fluid level remains below a high-level threshold level. A variety of sensors may be used to monitor the fluid level, including one or more of a mechanical sensor, an electrical sensor, an optical sensor, an electromechanical sensor, or combinations of the same. For example, a float may rest on a surface of the cutting fluid and indicate the fluid level to a position sensor (e.g., an encoder) via a shaft attached to the float. Alternatively, the shaft of the float may be directly coupled to a switch of a pump for evacuating cutting fluid from the fluid container.

Furthermore, as shown in FIG. 1, in some implementations, the fluid reclamation process includes an act 110 of pumping cutting fluid from the fluid container to a reservoir of the machine tool. To illustrate, a pump can move some (e.g., most) of the cutting fluid via a hose from the fluid container to the reservoir of the machine tool.

Additionally, in some implementations, the fluid reclamation process includes determining that the fluid level reaches (or exceeds) a predetermined high-level threshold level. For instance, once the sensor indicates that the fluid level reaches the high-level threshold, the pump can be activated to move cutting fluid from the fluid container, thereby reducing a height of the fluid level. In some cases, a float on the surface of the cutting fluid reaches the predetermined high-level threshold level and a shaft coupled to the float activates a switch that then initiates the pump.

Furthermore, in some implementations, the fluid reclamation process includes determining that the fluid level drops below a predetermined low-level threshold level. For example, as cutting fluid is moved from the fluid container, a sensor (or timer, etc.) may indicate that the fluid level reaches the low-level threshold. Upon such indication, the pump can be deactivated to allow more cutting fluid to accumulate in the fluid container. In some cases, by deactivating the pump while there is some cutting fluid remaining in the fluid container, the lifespan of the pump can be extended (e.g., by preventing the pump line from running dry while active). In some cases, a float on the surface of the cutting fluid reaches the predetermined low- level threshold level and a shaft coupled to the float deactivates a switch that then stops the pump. In some cases, a relay timer or some other electro-mechanical sensor/switch can be used to deactivate/stop the pump.

As also shown in FIG. 1, the acts 102-110 can be repeated in a cycle. In particular, the cutting fluid that is evacuated from the fluid container and moved to the reservoir of the machine tool (at act 110) can then be used in a machining operation and mixed with scrap chips (at act 102).

By way of example, in some implementations, a method for reclaiming a cutting fluid includes: operating a machine tool for machining metal or another rigid material; while operating the machine tool, collecting scrap chips and cutting fluid into a chip bin of the machine tool; draining excess cutting fluid from the scrap chips into a fluid container; monitoring, utilizing at least one of a mechanical sensor, an electrical sensor, an optical sensor, or an electromechanical sensor, a fluid level of the excess cutting fluid in the fluid container; determining that the fluid level reaches a predetermined high-level threshold level; turning on a pump to move at least a portion of the excess cutting fluid from the fluid container to a reservoir of the machine tool; during movement of the at least a portion of the excess cutting fluid, determining that the fluid level drops below a predetermined low-level threshold level; and turning off the pump. In some implementations, the disclosed methods for reclaiming cutting fluid do not include human input or interaction.

Alternatively, in some implementations, the excess cutting fluid is continuously (or intermittently) pumped from the fluid container to the reservoir of the machine tool, without monitoring of the fluid level. For example, in some cases, a pumping rate (e.g., volume flow rate) of the cutting fluid (out of the fluid container toward the reservoir) is established to match an accumulation rate (e.g., volume flow rate) of the cutting fluid (into the fluid container from the chip bin). Thus, in some implementations, the act of monitoring the fluid level may be omitted from the fluid reclamation process.

Moreover, in some implementations, the excess cutting fluid is pumped from the fluid container to a storage reservoir (e.g., not necessarily at the machine tool). For example, the excess cutting fluid is reclaimed and stored for a later (e.g., different) machining operation. Thus, while in some embodiments, cutting fluid can be reused in the same machining operation from which it was reclaimed, in other embodiments, cutting fluid can be reused in a different machining operation.

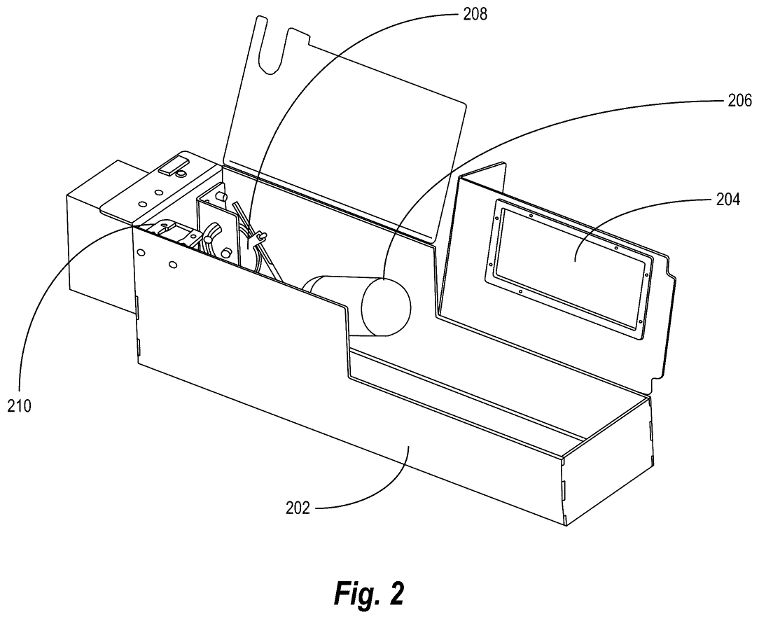

FIG. 2 illustrates some components of a fluid reclamation apparatus in accordance with one or more embodiments. Specifically, FIG. 2 shows a fluid container 202 for collecting a cutting fluid from a machining operation. FIG. 2 also shows a lid with an opening 204 through which the cutting fluid passes to accumulate in the fluid container 202. The fluid container 202 can be such to allow the cutting fluid to pass through the opening 204 in a specific side or orientation and/or allow the cutting fluid to pass through the opening 204 (or multiple openings) from multiple sides or orientations.

In some embodiments, a filter (or filters) for filtering the cutting fluid is positioned in the opening 204. For example, the filter(s) can filter the cutting fluid from scrap chips from the machining operation. In some cases, the filter(s) in the opening(s) 204 can be fixed, interchangeable, replaceable, etc. to accommodate different fluid viscosities and/or chip sizes/configurations. By pre-filtering the used cutting fluid, the fluid reclamation apparatus can help increase the longevity of the pump, and in some cases eliminate or at least reduce contaminates in the cutting fluid before reuse.

As also shown in FIG. 2, the fluid reclamation apparatus can include a sensor for detecting a fluid level of the cutting fluid within the fluid container 202. For example, the fluid reclamation apparatus can include a float 206 that tracks a surface of the cutting fluid. For instance, the float may have a density less than that of the cutting fluid, thereby maintaining the float 206 (or at least a portion of the float 206) above the surface of the cutting fluid. The float 206 can be connected to a meter 208 for detecting the fluid level. For example, a shaft may be coupled to the float 206 and to the meter 208, thereby effecting a change in a reading of the meter 208 as the float 206 rises or falls with the surface of the cutting fluid. The meter 208 can be any sensor to determine a level of the surface of the cutting fluid, such as a rotary sensor (e.g., a rotary encoder), a magnetic switch, a level switch, or a linear sensor (e.g., a linear encoder). Alternatively, the meter 208 can be a switch (e.g., a rotary switch) that initiates an actuator upon turning past a predetermined position. Additionally, or alternatively, the meter 208 can be a switch that activates a relay(s) and/or a timer to activate the pump to trigger ON/OFF.

In addition, the fluid reclamation apparatus can include an actuator (e.g., one or more of a variety of pumps), for moving the cutting fluid from the fluid container toward a reservoir of a machine tool. For example, FIG. 2 shows a bracket 210 for coupling a hose assembly and pump system to the fluid container 202. In some cases, the hose assembly can be rigidly fixed to the pump and/or utilize industry standard quick-disconnect fitting(s) such as cam & groove, push connect, etc. Further, the hose assembly can be mounted rigidly in a given orientation/direction and/or mounted such that the hose assembly can be oriented 360 degrees.

Furthermore, in some embodiments, the fluid reclamation apparatus includes a controller for initiating the actuator upon sensing, via the sensor, that the fluid level of the cutting fluid exceeds a predetermined threshold level. Any of a variety of controllers can be used, such as an on-off controller or a programmable logic controller.

By way of example, in some implementations, a fluid reclamation apparatus includes: a fluid container for collecting a cutting fluid from a machining operation; a filter for filtering the cutting fluid from scrap chips of the machining operation; a sensor for detecting a fluid level of the cutting fluid within the fluid container; an actuator for moving the cutting fluid from the fluid container toward a reservoir of a machine tool; a hose assembly coupled to the actuator to transfer the cutting fluid; and a controller for initiating the actuator upon sensing, via the sensor, that the fluid level of the cutting fluid exceeds a predetermined threshold level.

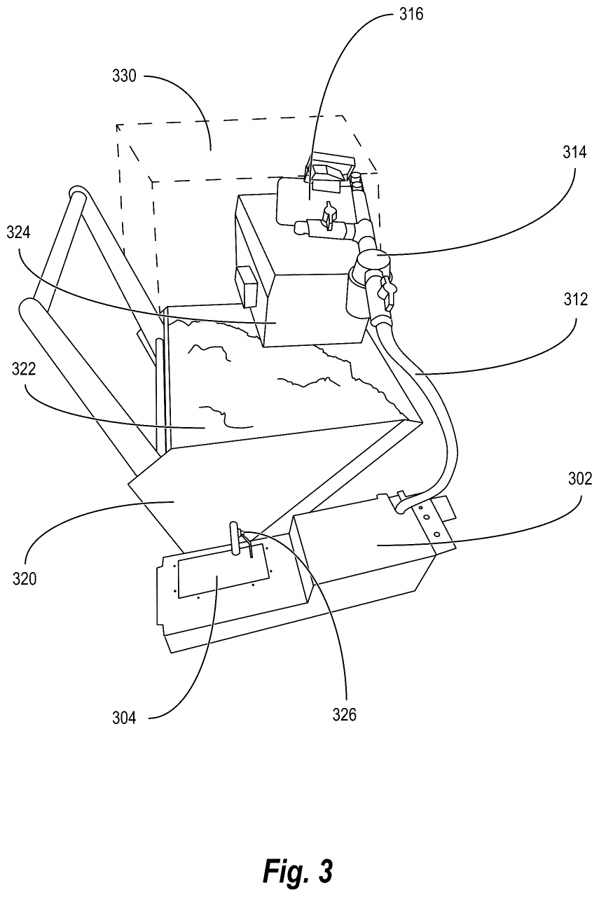

FIG. 3 illustrates a fluid reclamation system interfaced with a chip bin and a reservoir of a machine tool, in accordance with one or more embodiments.

In particular, FIG. 3 shows a fluid container 302 of the fluid reclamation system coupled to a chip bin 320. The chip bin 320 can collect scrap chips 322. For example, the scrap chips 322 are produced by a machine tool 330 during a machining operation, such as milling or turning of a workpiece. (The machine tool 330 is illustrated schematically as a dashed box and can be any type of machine tool, as described above.) The scrap chips can be captured and moved from the machine tool 330 via a conveyor system 324. In some cases, a cutting fluid is used during the machining operation to lubricate and cool the interface between the machine tool 330 and the workpiece, and to aid removal of scrap chips from the machine tool 330. The cutting fluid typically soaks the scrap chips 322 and makes up part of the material captured in the chip bin 320. Over time, a portion of the cutting fluid captured in the chip bin 320 can drain toward a bottom of the chip bin 320.

As shown in FIG. 3, in some embodiments, the chip bin 320 has a drain valve 326—adjacent the bottom of the chip bin 320—through which cutting fluid can drain from the chip bin 320 to the fluid container 302. In some embodiments, a filter 304 is coupled to an opening of the fluid container 302. The cutting fluid passes through the filter 304 to be filtered (e.g., to remove remaining scrap chips), and accumulates within the fluid container 302.

As described above, the fluid reclamation system can move cutting fluid from the fluid container 302 toward a reservoir of the machine tool 330 (or a storage reservoir). For example, a hose assembly 312 can extend into the fluid container 302 (or otherwise interface with the fluid container 302). An actuator 316 (e.g., a pump) coupled to the hose assembly 312 can be activated to transfer some (e.g., most) of the cutting fluid from the fluid container 302 to the reservoir of the machine tool 330. Thus, the cutting fluid can be recycled for additional use at the machine tool 330.

In some implementations, a filter 314 can be included in the pump/hose line to further filter (e.g., additionally or alternatively to the filter 304) the cutting fluid.

By way of example, in some implementations, a fluid reclamation system includes: a fluid container configured to interface with a chip bin of a machine tool and collect used cutting fluid from a machining operation; a sensor configured to detect a fluid level of the used cutting fluid within the fluid container; an actuator configured to move the used cutting fluid from the fluid container toward a reservoir of the machine tool; and a controller configured to initiate the actuator upon sensing, via the sensor, that the fluid level of the used cutting fluid exceeds a predetermined threshold level.

In some cases, a chip bin is used to collect scrap chips mingled with cutting fluid before draining the cutting fluid from the chip bin. For instance, in some cases, the chip bin is first positioned at a site of a machining operation to collect the scrap chips and the used cutting fluid, and can be proactively draining into a fluid reclamation container and/or later moved to a site of a fluid reclamation process to reclaim the cutting fluid. For example, reclaimed cutting fluid can be stored before being reused in a machining operation (e.g., the cutting fluid can be stored in a storage container near the site of the fluid reclamation process rather than being pumped directly back to the reservoir of the machine tool).

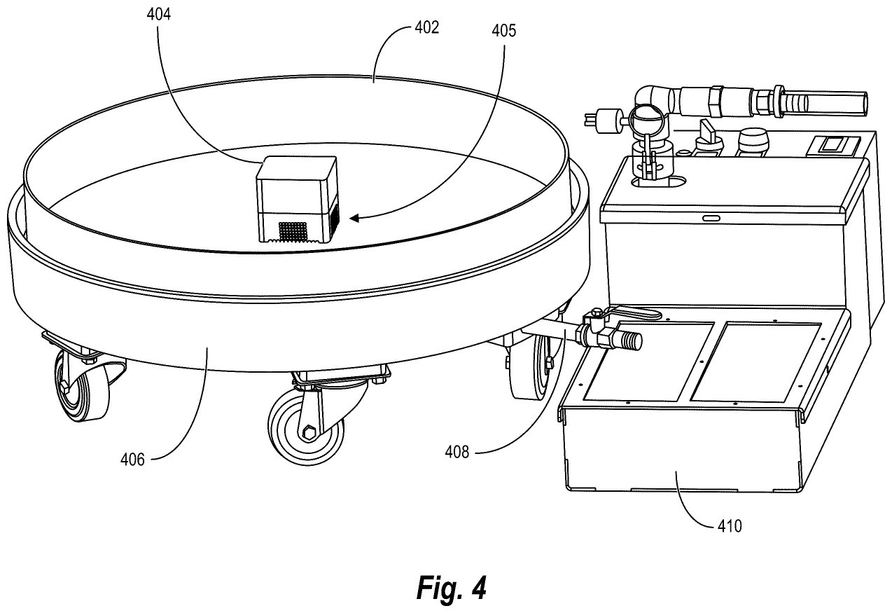

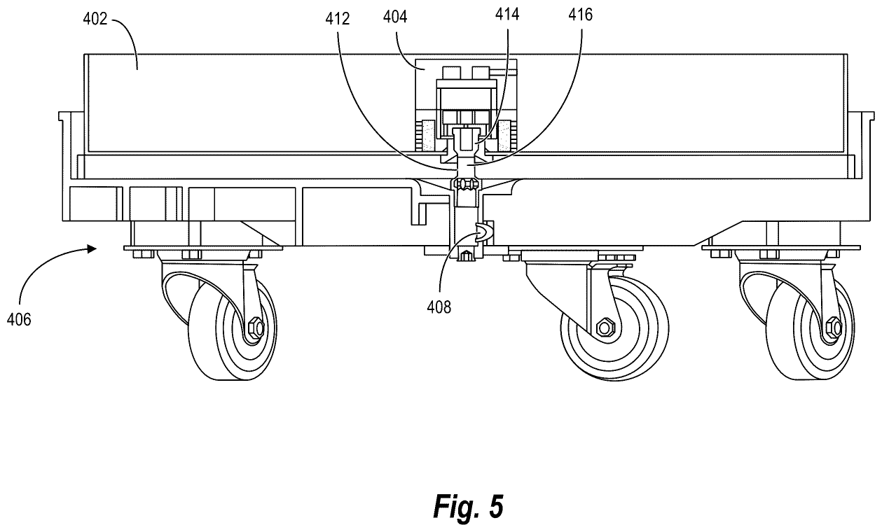

Moreover, in some cases, the chip bin needs to be moved for other reasons (e.g., to replace a full chip bin with an empty chip bin at the site of the machining operation). When a chip bin is filled with scrap chips and used cutting fluid, the chip bin can be very heavy. Moreover, when cutting fluid is not being drained into a fluid container, the chip bin should be plugged to prevent spills or leaks of cutting fluid. In some embodiments, a draining device can facilitate both draining of the cutting fluid and movement of the chip bin. For example, as described below in connection with FIGS. 4 and 5, a draining device can provide mobility for the chip bin while also supplying a draining mechanism for the cutting fluid.

FIG. 4 illustrates a portion of a fluid reclamation system in accordance with one or more embodiments. In particular, FIG. 4 shows a cutaway view of a chip bin 402 (e.g., a top portion of the chip bin is cut away from the view). In some embodiments, the chip bin 402 is a barrel or a drum (e.g., a 55-gallon drum). The chip bin 402 can have a drain (e.g. an opening in the bottom of the chip bin) for cutting fluid to flow through.

Moreover, in some implementations, a plug assembly 404 is coupled to the chip bin 402 at the drain of the chip bin 402. The plug assembly 404 can plug the drain to stop and/or prevent flow of cutting fluid through the drain. For example, while at the site of the machining operation, a plug of the plug assembly 404 can be engaged with the drain to prevent flow of the cutting fluid. Then, when at the site of the fluid reclamation process, the plug of the plug assembly 404 can be disengaged with the drain to allow the cutting fluid to flow through the drain and out of the chip bin 402. As illustrated, the plug assembly 404 can have one or more openings 405 through which the cutting fluid can flow towards the drain of the chip bin 402.

In some embodiments, the chip bin 402 is placed onto a draining device 406. As mentioned, the draining device 406 can be mobile (e.g., via wheels and/or casters) to facilitate movement of the chip bin 402. To illustrate, the draining device can include a drum dolly or some other cart or trolley. Additionally, the draining device 406 can include a drain line 408. The drain line 408 can be in fluid communication with a port of the draining device 406. When the chip bin 402 is coupled to the draining device 406, the drain of the chip bin 402 can be in fluid communication with the port of the draining device 406 and the drain line 408. Furthermore, a plug engagement mechanism on the draining device 406 can engage the plug of the plug assembly 404 to unplug the drain of the chip bin 402, thereby opening up the chip bin 402 into fluid communication with the drain line 408 (through the one or more openings 405 of the plug assembly 404 and through the drain of the chip bin 402). When draining the chip bin 402, the drain line 408 can be positioned at a fluid container 410 to drain the cutting fluid into the fluid container 410. As described above, the fluid container 410 can accumulate cutting fluid and can be drained of the cutting fluid via an actuator (e.g., a pump).

In some implementations, the drain line 408 includes an on/off valve to control flow of cutting fluid through the drain line 408. For instance, in some cases, the chip bin 402 is coupled with the draining device 406 and the plug assembly 404 is engaged in an open state to allow cutting fluid to drain from the chip bin 402 through the plug assembly 404 and the draining device 406. Nevertheless, at certain times draining of the cutting fluid may be undesirable (e.g., before the chip bin 402 and the draining device 406 are positioned at the fluid container 410). Thus, the on/off valve of the drain line 408 may be shut off to prevent draining. When draining of the cutting fluid is desired, the on/off valve can be opened on to allow draining of the cutting fluid.

FIG. 5 illustrates a cross section view of the chip bin 402, the plug assembly 404, and the draining device 406 in accordance with one or more embodiments. In this view, the chip bin 402 also has a top portion cut away (as in FIG. 4). As illustrated, the chip bin 402 has a drain 412 at a bottom of the chip bin 402. Additionally, the plug assembly 404 has a plug 414 that can close the drain 412 to stop flow of cutting fluid through the drain 412. Furthermore, the draining device 406 has a plug engagement mechanism 416 that can engage the plug 414 to open the plug.

For example, in some embodiments, the plug engagement mechanism 416 is a pin or a shaft that presses the plug 414 out of the drain 412. In some cases, the plug assembly 404 includes a spring mechanism that pushes the plug 414 towards a state of closing the drain 412. The plug engagement mechanism 416 of the draining device 406 can counteract the spring mechanism by pushing the plug 414 in an opposite direction to compress the spring mechanism and open the drain 412.

In some embodiments, the plug assembly 404 filters the used cutting fluid as the cutting fluid drains out of the chip bin 402. For example, the plug assembly 404 can have many small openings and/or screen(s) (e.g., the openings 405 shown in FIG. 4) that generally inhibit scrap chips from passing through, but that allow cutting fluid to flow through towards the drain 412 of the chip bin 402.

By way of example, in some implementations, a fluid reclamation system includes a chip bin configured to collect used cutting fluid with scrap chips from a machining operation; a draining device configured to interface with the chip bin to provide fluid communication between an interior of the chip bin and a drain line of the draining device; a plug assembly positioned at a drain of the chip bin, the plug assembly comprising a plug configured to close the drain when the chip bin is separated from the draining device and to open the drain when the chip bin is interfaced with the draining device; a fluid container configured to receive the used cutting fluid from the chip bin via the draining device; a sensor configured to detect a fluid level of the used cutting fluid within the fluid container; an actuator configured to move the used cutting fluid from the fluid container toward a reservoir of a machine tool (or any designated area/reservoir); and a controller configured to initiate the actuator upon sensing, via the sensor, that the fluid level of the used cutting fluid exceeds a predetermined threshold level.

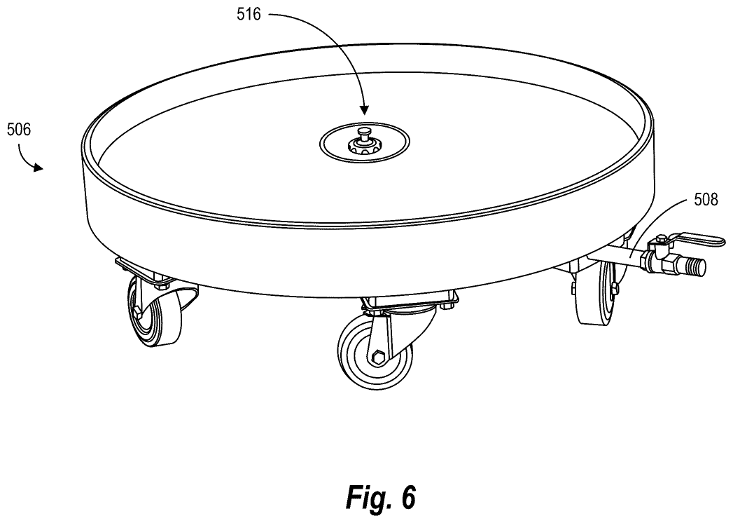

FIG. 6 illustrates a draining device in accordance with one or more embodiments. In particular, FIG. 6 shows a perspective view of a draining device 506 with a plug engagement mechanism 516 and a drain line 508. In this view, the draining device 506 is uncoupled from a chip bin (whereas the view of FIG. 4 includes the chip bin 402). The draining device 506 is similar to the draining device 406, and the plug engagement mechanism 516 is similar to the plug engagement mechanism 416 shown in FIG. 5.

In particular, the plug engagement mechanism 516 has a pin or shaft that can engage a plug of a chip bin to open the plug and bring the chip bin into fluid communication with the drain line 508. For example, as shown, the plug engagement mechanism 516 in adjacent one or more holes through which cutting fluid can flow towards the drain line 508 (in similar fashion to the drain line 408 described above in connection with FIGS. 4 and 5).

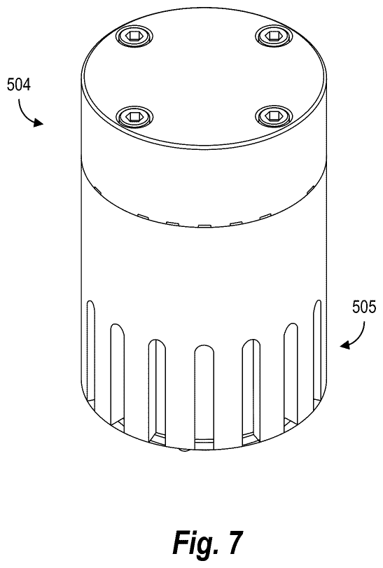

FIG. 7 illustrates a plug assembly 504 in accordance with one or more embodiments. Similar to the plug assembly 404 described above, the plug assembly 504 can plug a chip bin when in a closed configuration, and can allow cutting fluid to flow out of the chip bin when in an open configuration. For example, the plug assembly 504 has a series of openings 505 through which cutting fluid can flow towards a drain of the chip bin when the plug assembly 504 is in an open configuration (e.g., when engaged with the plug engagement mechanism 516 of the draining device 506).

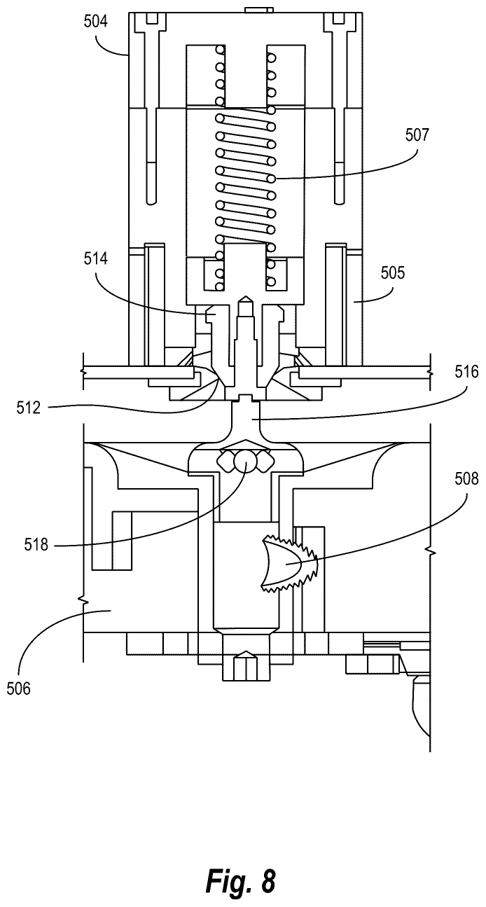

FIG. 8 illustrates a detail cross section view of a plug assembly coupled with a chip bin and interfacing with a draining device in accordance with one or more embodiments. In particular, FIG. 8 shows the plug assembly 504 engaged with the plug engagement mechanism 516 of the draining device 506. While this view is similar to the cross section view of FIG. 5, the view of FIG. 8 is a close-up view to focus on the details of the plug assembly 504 and the plug engagement mechanism 516, and thus shows only a portion of the draining device 506.

More particularly, the plug assembly 504 includes a plug 514 that stops cutting fluid from draining out of the chip bin when in a closed state. For example, the chip bin has a drain 512 at a bottom of the chip bin. The plug 514 of the plug assembly 504 can close the drain 512 to stop the flow of cutting fluid through the drain 512. However, when the chip bin is coupled to the draining device 506, the plug engagement mechanism 516 pushes the plug 514 to open the drain 512 and allow cutting fluid to flow. For example, when the plug is open, cutting fluid can flow from the inside of the chip bin through the series of openings 505, through the drain 512, past the plug engagement mechanism 516, through holes 518 in the draining device 506, and then through the drain line 508 towards a fluid container (such as the fluid container 410 described above).

Similar to the plug assembly 404 described above, the plug assembly 504 can have a spring 507 (or a plurality of springs, such as two, three, four, or more) that pushes the plug 514 into a closed state (e.g., to close the drain 512 of the chip bin). The plug engagement mechanism 516 of the draining device 506 can counteract the spring 507 by pushing the plug 514 in an opposite direction of the spring force to compress the spring 507 and open the drain 512.

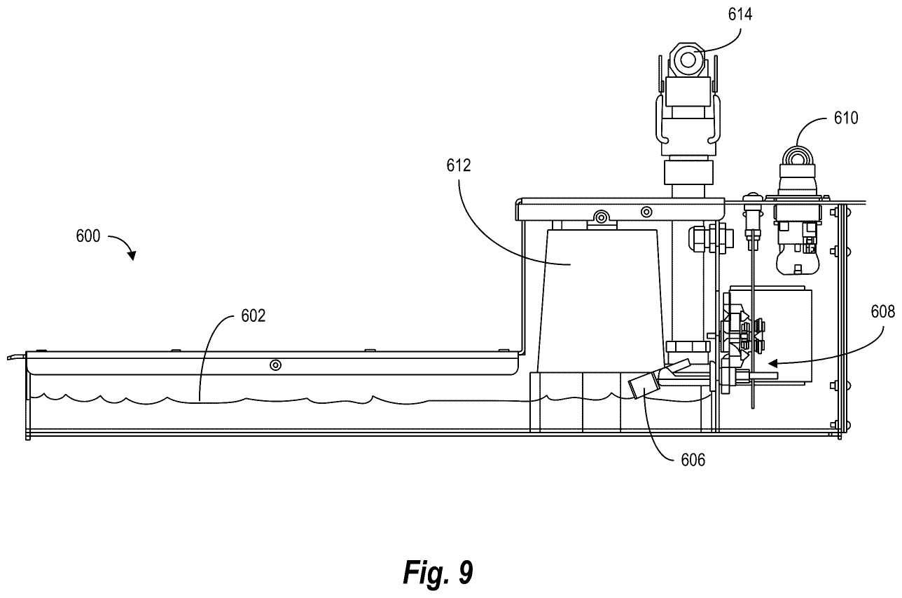

FIG. 9 illustrates a fluid reclamation apparatus in accordance with one or more embodiments. In particular, FIG. 9 shows a cutaway view (e.g., with a side panel removed) of a fluid container 600 for collecting a cutting fluid 602 from a machining operation. For example, the fluid container 600 can receive the cutting fluid 602 from a chip bin that holds scrap chips mingled with cutting fluid, as described above. In the view of FIG. 9, the fluid container 600 is partially filled with the cutting fluid 602.

Additionally, a sensor 606 can determine a cutting fluid level of the cutting fluid 602 within the fluid container 600. For example, the sensor includes a float that can rise with the cutting fluid level within the fluid container 600. Moreover, an actuator 612 can move the cutting fluid 602 from the fluid container 600 to a reservoir (e.g., a reservoir at a machine tool or a storage reservoir elsewhere). For example, the actuator 612 includes a pump that can pump the cutting fluid out of the fluid container 600 through a hose assembly 614.

Furthermore, a controller 608 can initiate the actuator 612 upon sensing, via the sensor 606, that the cutting fluid level exceeds a predetermined threshold level. For example, the controller 608 includes a switch coupled to the sensor 606 (e.g., the float) that triggers the actuator 612 (e.g., initiates the pump) to move the cutting fluid 602.

In some embodiments, one or more of the sensor 606, the actuator 612, and/or the controller 608 use electrical power. The fluid reclamation apparatus can include a power supply or a power plug 610 through which electrical power can be delivered. For example, in some embodiments, the actuator 612 is an electric pump that receives power through the power plug 610.

As described above in connection FIGS. 2 and 3, in some embodiments, the fluid reclamation apparatus includes a timer (e.g., at the controller 608) configured to deactivate the actuator 612 after a period of time upon actuation. For example, in some implementations, the fluid reclamation apparatus operates the pump for a fixed amount of time upon activation by the switch. Alternatively, in some implementations, the fluid reclamation apparatus periodically operates the pump based on a known interval of cutting fluid filling inside the fluid container.

### EXAMPLES

The following are some example embodiments within the scope of the disclosure. In order to avoid complexity in providing the disclosure, not all of the examples listed below are separately and explicitly disclosed as combinable with all of the others of the examples listed below and other embodiments disclosed hereinabove. Unless one of ordinary skill in the art would understand that these examples listed below, and the above disclosed embodiments, are not combinable, it is contemplated within the scope of the disclosure that such examples and embodiments are combinable.

Example 1. A fluid reclamation apparatus comprising: a fluid container for collecting a cutting fluid from a machining operation; a sensor for determining a cutting fluid level within the fluid container; an actuator for moving the cutting fluid from the fluid container to a reservoir; and a controller for initiating the actuator upon sensing, via the sensor, that the cutting fluid level exceeds a predetermined threshold level.

Example 2. The fluid reclamation apparatus of Example 1, further comprising: a first filter for filtering the cutting fluid upon entry into the fluid container; and a second filter for further filtering the cutting fluid upon exit from the fluid container.

Example 3. The fluid reclamation apparatus of Example 2, wherein the first filter is interchangeable with a third filter to accommodate various cutting fluid viscosities.

Example 4. The fluid reclamation apparatus of Example 1, wherein the sensor comprises a float configured to rise with the cutting fluid level within the fluid container.

Example 5. The fluid reclamation apparatus of Example 4, wherein the actuator comprises a pump, and wherein the controller comprises a switch coupled to the float and configured to initiate the pump.

Example 6. The fluid reclamation apparatus of Example 1, wherein the controller comprises a timer configured to deactivate the actuator after a period of time upon actuation of the actuator.

Example 7. A fluid reclamation system comprising: a chip bin configured to interface with a machine tool to collect scrap chips mingled with used cutting fluid from a machining operation; a fluid container configured to interface with the chip bin to collect the used cutting fluid; a sensor configured to determine a cutting fluid level within the fluid container; an actuator configured to move the used cutting fluid from the fluid container to a reservoir; and a controller configured to initiate the actuator upon sensing, via the sensor, that the cutting fluid level exceeds a predetermined threshold level.

Example 8. The fluid reclamation system of Example 7, further comprising: a first filter configured to filter the used cutting fluid upon entry into the fluid container; and a second filter configured to filter the used cutting fluid upon exit from the fluid container.

Example 9. The fluid reclamation system of Example 8, wherein the first filter is interchangeable with a third filter to accommodate various cutting fluid viscosities and scrap chip sizes.

Example 10. The fluid reclamation system of Example 7, wherein the sensor comprises a float configured to rise with the cutting fluid level within the fluid container.

Example 11. The fluid reclamation system of Example 10, wherein the actuator comprises a pump, and wherein the controller comprises a switch configured to initiate the pump.

Example 12. The fluid reclamation system of Example 7, further comprising an agitator device or spinning device configured to increase an amount of the used cutting fluid that drains from the scrap chips within the chip bin.

Example 13. A method for reclaiming a cutting fluid, the method comprising: collecting scrap chips and cutting fluid from a machine tool into a chip bin; draining at least a portion of the cutting fluid from the chip bin into a fluid container; and pumping the portion of the cutting fluid from the fluid container to a reservoir for reuse in a machining operation.

Example 14. The method of Example 13, further comprising: monitoring a cutting fluid level in the fluid container; and determining that the cutting fluid level reaches a predetermined high-level threshold level.

Example 15. The method of Example 14, wherein pumping the portion of the cutting fluid from the fluid container to the reservoir comprises turning on a pump to move the portion of the cutting fluid from the fluid container to the reservoir in response to determining that the cutting fluid level reaches the predetermined high-level threshold level.

Example 16. The method of Example 15, further comprising: during movement of the portion of the cutting fluid from the fluid container to the reservoir, determining that the cutting fluid level drops below a predetermined low-level threshold level; and turning off the pump.

Example 17. The method of Example 14, wherein monitoring the cutting fluid level in the fluid container comprises utilizing at least one of a mechanical sensor, an electrical sensor, an optical sensor, or an electromechanical sensor to monitor the cutting fluid level.

Example 18. The method of Example 14, wherein determining that the cutting fluid level reaches the predetermined high-level threshold level comprises activating a switch to initiate pumping of the portion of the cutting fluid.

Example 19. The method of Example 13, wherein collecting the scrap chips and the cutting fluid comprises collecting the scrap chips and the cutting fluid into the chip bin while operating the machine tool in a machining operation.

Example 20. The method of Example 13, wherein draining the portion of the cutting fluid from the chip bin into the fluid container comprises disengaging a plug of the chip bin to permit the portion of the cutting fluid to flow out of the chip bin.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A fluid reclamation apparatus comprising:
a fluid container for collecting a cutting fluid from a machining operation;
a sensor for determining a cutting fluid level within the fluid container;
an actuator for moving the cutting fluid from the fluid container to a reservoir; and
a controller for initiating the actuator upon sensing, via the sensor, that the cutting fluid level exceeds a predetermined threshold level.

2. The fluid reclamation apparatus of claim 1, further comprising:
a first filter for filtering the cutting fluid upon entry into the fluid container; and
a second filter for further filtering the cutting fluid upon exit from the fluid container.

3. The fluid reclamation apparatus of claim 2, wherein the first filter is interchangeable with a third filter to accommodate various cutting fluid viscosities.

4. The fluid reclamation apparatus of claim 1, wherein the sensor comprises a float configured to rise with the cutting fluid level within the fluid container.

5. The fluid reclamation apparatus of claim 4, wherein the actuator comprises a pump, and wherein the controller comprises a switch coupled to the float and configured to initiate the pump.

6. The fluid reclamation apparatus of claim 1, wherein the controller comprises a timer configured to deactivate the actuator after a period of time upon actuation of the actuator.

7. A fluid reclamation system comprising:
a chip bin configured to interface with a machine tool to collect scrap chips mingled with used cutting fluid from a machining operation;
a fluid container configured to interface with the chip bin to collect the used cutting fluid;
a sensor configured to determine a cutting fluid level within the fluid container;
an actuator configured to move the used cutting fluid from the fluid container to a reservoir; and
a controller configured to initiate the actuator upon sensing, via the sensor, that the cutting fluid level exceeds a predetermined threshold level.

8. The fluid reclamation system of claim 7, further comprising:
a first filter configured to filter the used cutting fluid upon entry into the fluid container; and
a second filter configured to filter the used cutting fluid upon exit from the fluid container.

9. The fluid reclamation system of claim 8, wherein the first filter is interchangeable with a third filter to accommodate various cutting fluid viscosities and scrap chip sizes.

10. The fluid reclamation system of claim 7, wherein the sensor comprises a float configured to rise with the cutting fluid level within the fluid container.

11. The fluid reclamation system of claim 10, wherein the actuator comprises a pump, and wherein the controller comprises a switch configured to initiate the pump.

12. The fluid reclamation system of claim 7. further comprising an agitator device or spinning device configured to increase an amount of the used cutting fluid that drains from the scrap chips within the chip bin.

13. A method for reclaiming a cutting fluid, the method comprising:
collecting scrap chips and cutting fluid from a machine tool into a chip bin;
draining at least a portion of the cutting fluid from the chip bin into a fluid container; and
pumping the portion of the cutting fluid from the fluid container to a reservoir for reuse in a machining operation.

14. The method of claim 13, further comprising:
monitoring a cutting fluid level in the fluid container; and
determining that the cutting fluid level reaches a predetermined high-level threshold level.

15. The method of claim 14, wherein pumping the portion of the cutting fluid from the fluid container to the reservoir comprises turning on a pump to move the portion of the cutting fluid from the fluid container to the reservoir in response to determining that the cutting fluid level reaches the predetermined high-level threshold level.

16. The method of claim 15, further comprising:
during movement of the portion of the cutting fluid from the fluid container to the reservoir, determining that the cutting fluid level drops below a predetermined low-level threshold level; and
turning off the pump.

17. The method of claim 14, wherein monitoring the cutting fluid level in the fluid container comprises utilizing at least one of a mechanical sensor, an electrical sensor, an optical sensor, or an electromechanical sensor to monitor the cutting fluid level.

18. The method of claim 14, wherein determining that the cutting fluid level reaches the predetermined high-level threshold level comprises activating a switch to initiate pumping of the portion of the cutting fluid.

19. The method of claim 13, wherein collecting the scrap chips and the cutting fluid comprises collecting the scrap chips and the cutting fluid into the chip bin while operating the machine tool in a machining operation.

20. The method of claim 13, wherein draining the portion of the cutting fluid from the chip bin into the fluid container comprises disengaging a plug of the chip bin to permit the portion of the cutting fluid to flow out of the chip bin.
